(19) United States
(12) Patent Application Publication
(10) Pub. No.: US 2004/0093324 A1
(43) Pub. Date: May 13, 2004

(54) System and method for data collection using subject records

(75) Inventor: Kumar Marappan, Round Rock, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/290,352

(22) Filed: Nov. 7, 2002

(51) Int. Cl. G06F 7/00

(52) U.S. Cl. 707/3

(57) ABSTRACT

A system and method for data collection using subject records is presented. A system analyst uses a data manager which displays subject records and corresponding keywords. The system analyst uses the subject records and keywords as prompters to ask targeted questions while gathering information. The system analyst enters text corresponding to the keywords in the data manager, and the data manager matches the text with stored keywords to determine whether the text corresponds to a keyword. If the data manager detects a match, the data manager highlights the matched text and links the matched text to the matched keywords. The system analyst may select the highlighted text and the data manager displays subject records which include the matched keywords. The system analyst may review the displayed subject records and determine whether further targeted questions should be asked in order to obtain essential information.

### BACKGROUND OF THE INVENTION

1. Technical Field

The present invention relates in general to a system and method for data collection using subject records. More particularly, the present invention relates to a system and method for using keywords associated with subject records as prompters during data collection activity and storing collected data in the subject records.

2. Description of the Related Art

Companies spend much time at beginning stages of a product development in planning characteristics of a product. Companies realize that characterizing a product early in the development stages increases the chances of the product development effort meeting schedules budgets, and a resulting marketable product. Requirements gathering is an integral part of product characterization. A system analyst obtains information from people such as customers, vendors, and engineers. For example, a company may wish to build a computer system and a system analyst may ask customers their requirements, ask engineers various technical questions regarding computer systems, and ask vendors various pricing and availability questions.

Some requirements may be more essential than other requirements. A key element in obtaining essential requirements is asking targeted questions. For example, a customer may not precisely know his requirements and a targeted question may initiate the customer's thought process in a particular direction in which the customer concludes his requirements. Asking targeted questions usually comes with experience. Using the example described above, an experienced computer system developer may be able to interview a customer and gather essential requirements due to the fact that the computer system developer knows which targeted questions to ask the customer. In contrast, an inexperienced computer system developer may interview a customer and not obtain essential requirements simply due to the fact that he does not know which targeted questions to ask the customer. A challenge found is providing a system analyst with necessary information in order for the system analyst to ask targeted questions.

A system analyst uses data collection tools to store gathered requirements. A data collection tool may be a word processor, or a Lotus Notes database. However, some product development projects may be extremely large. Using the example described above, the computer system development project may have over 1,000 requirements, many of which relate to each other.

When a system analyst enters information into a data collection tool, the data collection tool typically receives the data and stores it in a storage location. However, the information may be relevant to other requirements within the product development effort. Using the example described above, a system analyst may enter information regarding operating costs that include the words “power dissipation”. In this example, a separate “power dissipation” requirement may be one of 1,000 requirements to obtain information and the system analyst may not have the foresight to ask additional questions regarding power dissipation. A challenge found is identifying particular parts of information that require further questioning in order to obtain sufficient detail regarding related requirements.

What is needed, therefore, is a system and method to allow a system analyst to identify targeted questions and be notified when collected data is pertinent to other requirements within a product development effort.

### SUMMARY

It has been discovered that the aforementioned challenges are resolved by using subject records with corresponding keywords to prompt a user to gather essential information and store the information in corresponding data collection storage areas. The information is matched with keywords and the user is notified when the information corresponds to other subject records (i.e. requirements).

The user uses a data manager to retrieve and display subject records. Each subject record includes keywords that the user employs as reminders when gathering information for a particular project. For example, the user may be gathering requirements for a new software product, and may use the subject records as reminders as to what questions to ask a customer or a computer programmer. Using the example described above, subject records corresponding to the software development may be “Database”, “Validations”, and “Search”. Each subject record includes one or more associated keywords. Using the example described above, keywords included in the “Database” subject record may be “Data Type”, “Nullable”, “Default”, “Performance”, and “Migration”. The data manager highlights a keyword (i.e. underlined) when the keyword has a corresponding subject record. Using the example described above, “Migration” may be underlined and have a corresponding subject record that includes keywords that segment “Migration” into more detail.

When the user wishes to enter data corresponding to a particular keyword, the user selects the keyword and the data manager displays a data collection screen. The user may add free form text, assign an action item, and specify various parameters of a keyword using the data collection screen. When the user enters free form text, the data manager progressively matches the free form text with stored keywords. The data manager may include a word number configuration property that corresponds to the number of successive free form text words that the data manager matches with stored keywords. For example, if the word number configuration property is “3”, then the data manager progressively matches up to three free form text words at a time with stored keywords.

When the data manager detects a match between free form text and a stored keyword, the data manager creates a link between the matched free form text and subject records that include matched keywords. The data manager also highlights the matched free form text on the user's display to inform the user that subject records exists that have keywords that match the free form text. The user selects the highlighted text and the data manager retrieves and displays the linked subject records. The user reviews the linked subject records to determine if more targeted questions should be asked in order to obtain essential requirements corresponding to the subject record.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a user selecting a subject record and entering free form text corresponding to the subject record;

FIG. 2 is a diagram showing a user selecting subject records and the user entering free form text in corresponding data collection screens;

FIG. 3 is a user interface screen showing data collection screen fields;

FIG. 4 is a high level diagram showing a user sending a request corresponding to requirement gathering activities;

FIG. 5 is a flowchart showing a user adding a new keyword or a new subject record;

FIG. 6 is a flowchart showing steps taken in receiving free form text and matching the free form text with stored keywords and subject records;

FIG. 7A is a group of unstacked subject records with corresponding keywords;

FIG. 7B is a group of stacked subject records with corresponding keywords;

FIG. 8 is a user interface screen showing a consolidated view of various subject records and corresponding keyword information; and

FIG. 9 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

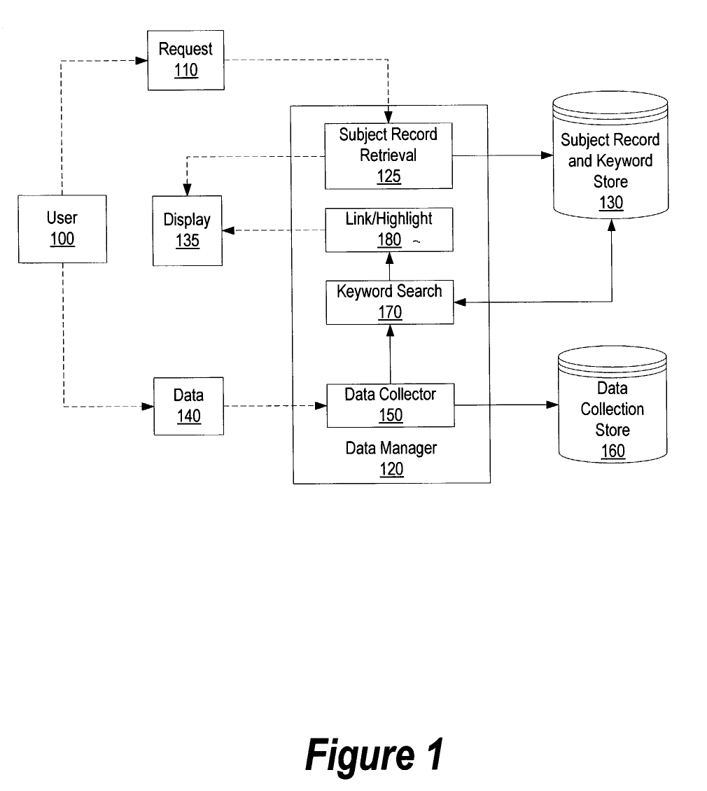

FIG. 1 is a high level diagram showing a user selecting a subject record and entering free form text corresponding to the subject record. User 100 uses data manager 120 to retrieve and display subject records. Each subject record includes keywords that user 100 uses as a data collection prompter when gathering information for a particular project. A keyword, when used as a data collection prompter, reminds user 100 as to what questions to ask in order to obtain relevant data. The keywords are words that do not include a network address. For example, the user may be gathering requirements to build an automobile, and may use the keywords as reminders as to what information to obtain from a customer or an automotive engineer. Using this examples example, one subject record may be titled “Fuel Efficiency” and corresponding keywords may be “Automobile Weight”, “Engine Efficiency”, Transmission Gear Ratio”, “Tire Width”, and “Aerodynamic Drag”.

User 100 sends request 110 to data manager 120. Request 110 includes a request to retrieve a particular subject record. Subject record retrieval 125 analyzes the request, and retrieves the corresponding subject record from subject record and keyword store 130. Subject record and keyword store 130 may be stored on a non-volatile storage area, such as a computer hard drive. Subject record retrieval 125 displays the requested subject record with corresponding keywords on display 135. Using the example described above, the subject record “Fuel Efficiency” with keywords “Automobile Weight”, “Engine Efficiency”, Transmission Gear Ratio”, “Tire Width”, and “Aerodynamic Drag” are displayed on display 135.

User 100 reviews the keywords and determines if he wishes to add data to a particular keyword or select a different subject record. If a keyword is highlighted (i.e. underlined) within a subject record, the highlighted keyword has a corresponding subject record. Using the example described above, the keyword “Truck Weight” may be highlighted. User 100 may send a second request 110 which selects a highlighted keyword. Subject record retrieval 120 retrieves the corresponding subject record from subject record store 130 and displays the new subject record on display 135. Using the example described above, user 110 may select “Truck Weight” and processing displays subject record “Truck Weight” that includes keywords “Chassis Weight”, “Shell Weight”, “Engine Weight”, and “Transmission Weight”.

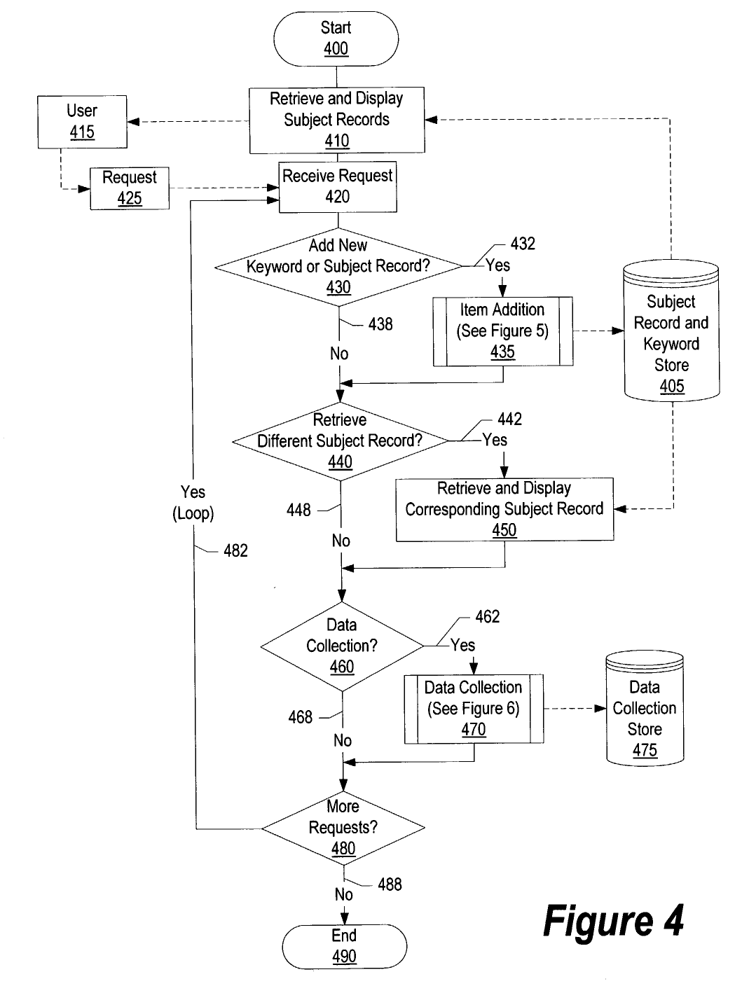

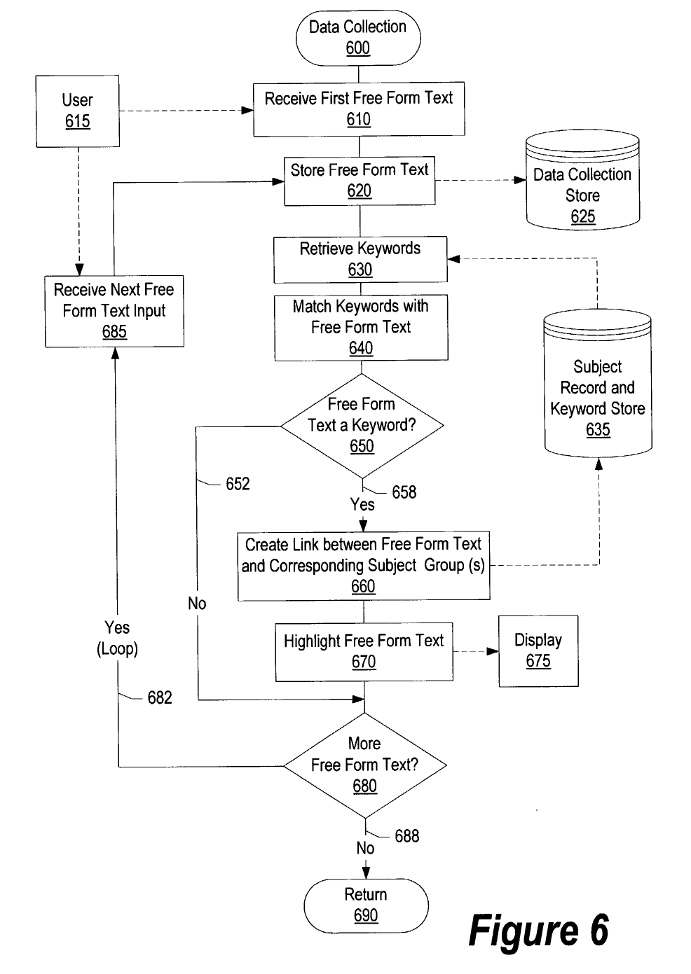

User 100 also uses data manager 120 to associate data to keywords. User 100 may wish to add free form text, assign an action item, and specify various parameters of a keyword (see FIGS. 4, 6, and corresponding text for further details regarding data collection). Using the example described above, user 100 may be gathering information from an automotive engineer and wish to store the information, such as an estimated transmission weight. When user 100 is ready to associate data to a keyword, user 100 sends data 140 to data manager 120. Data collector 150 receives the data and stores the data in data collection store 160. Data collection store may be stored on a nonvolatile storage area, such as a computer hard drive.

If data 140 includes free form text, data collector 150 also sends the free form text to keyword search 170. Keyword search 170 progressively matches the free form text with keywords stored in subject record and keyword store 130. Keyword search 170 may include a word number configuration property that corresponds to the number of successive words that keyword search 170 matches with keywords. For example, if the word number configuration property is “3”, then keyword search progressively compares up to three words at a time to stored keywords (see FIG. 6 and corresponding text for further details regarding keyword matching). If keyword search 170 detects a match, keyword search invokes link/highlight 180. Link/highlight 180 creates a link between the free form text and other subject records that include the matched keyword and also highlights the matched freeform text on display 135. Using the example described above, the user enters free form text for “Transmission Weight”, such as “transmission weight dependent upon transmission gear ratio”, and the keyword “Transmission Gear Ratio” may be a keyword in a “Towing Capacity” subject record. In this example, link/highlight 180 highlights “transmission gear ratio” and creates a link between the free form text and the “Towing Capacity” subject record.

When user 100 identifies highlighted text on display 135, user 100 is able to select the highlighted text and data manager 120 retrieves and displays subject records linked to the highlighted free form text.

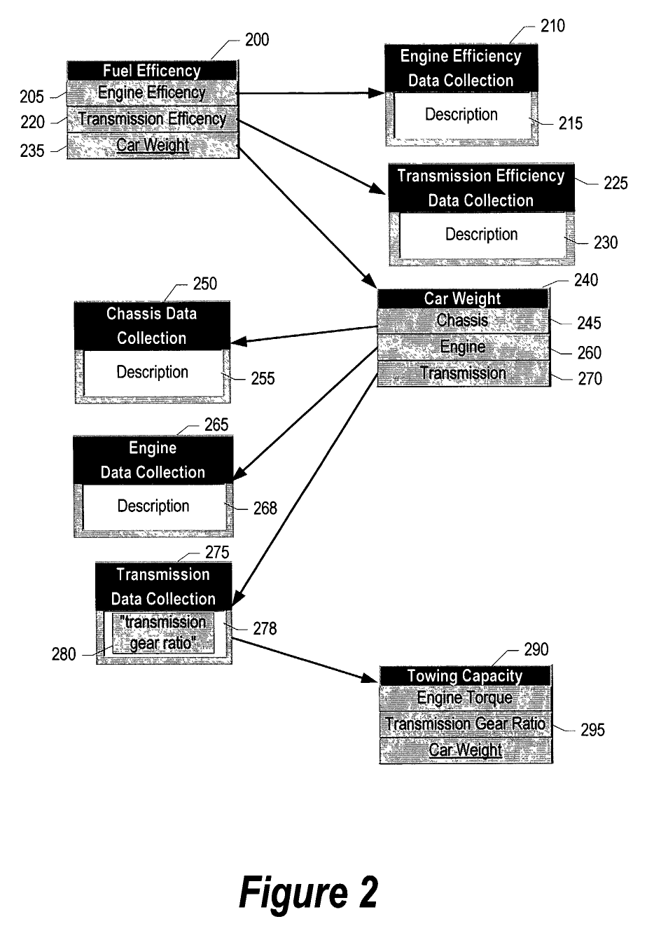

FIG. 2 is a diagram showing a user selecting subject records and entering free form text in corresponding data collection screens. Subject records include keywords that prompt a user to ask particular questions when gathering information corresponding to a project. Subject record 200 includes keyword 205, keyword 220, and keyword 235. When the user selects keyword 205, processing displays collection screen 210. The user enters free form text corresponding to keyword 205 in description area 215. When the user selects keyword 220, processing displays data collection screen 225 and the user enters free form text corresponding to keyword 220 in description area 230.

If a keyword is highlighted (i.e. underlined, bolded, etc.), the keyword has a corresponding subject record, such as keyword 235. When the user selects keyword 235, processing displays subject record 240 which corresponds to keyword 235 and includes keyword 245, keyword 260, and keyword 270. The user may subsequently select keyword 245, keyword 260, or keyword 270 and enter free form text corresponding to each keyword. When the user selects keyword 245, processing displays data collection screen 250 and the user enters free form text corresponding to keyword 245 in description area 255. When the user selects keyword 260, processing displays data collection screen 265 and the user enters free form text corresponding to keyword 260 in description area 269. When the user selects keyword 270, processing displays data collection screen 275 and the user enters free form text corresponding to keyword 260 in description area 278.

When a user enters free form text in a description area, processing matches the free form text with stored keywords. If processing detects a match, processing highlights matched free form text, and creates a link between the free form text and subject records that include the matched keyword (see FIG. 6 and corresponding text for further details regarding keyword matching). Description area 278 includes highlighted text 280 which has been matched with a stored keyword. FIG. 2 shows that subject record 290 appears when a user selects highlighted text 280 since subject record 290 includes keyword 295 that matches highlighted text 280.

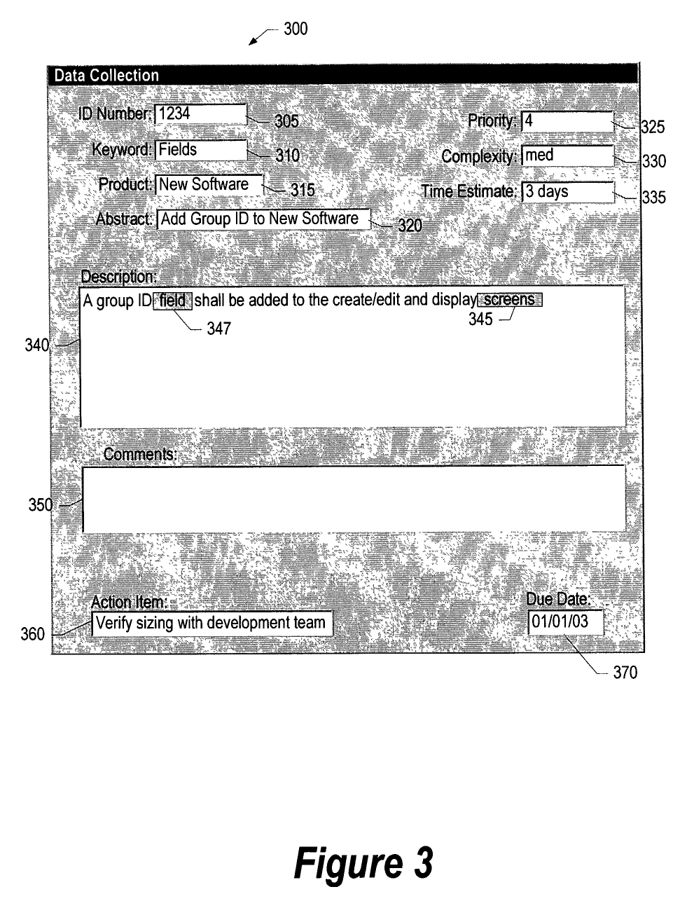

FIG. 3 is a user interface screen showing data collection screen fields. A user uses data collection screen 300 to enter keyword data corresponding to a particular keyword. Data collection screen 300 includes various data entry fields displayed in text boxes. These text boxes include identification number text box 305, keyword text box 310, product text box 315, abstract text box 320, priority text box 325, complexity text box 330, and time estimate text box 335.

Identification number text box 305 includes a number corresponding to the keyword that processing may automatically generate. The identification number may be used to track action items corresponding to the keyword. Keyword text box 310 includes the name of the keyword. Product text box 315 is the name of a product that corresponds to the keyword, such as “New Software”. A user may add an abstract corresponding to the keyword in abstract text box 320. The user enters a priority level in priority text box 325 corresponding to the importance of the keyword's requirements. The user enters a complexity level in complexity text box 330 which corresponds to the complexity of achieving the keyword's requirements. The user enters a time estimation in time estimate text box 335 which corresponds to an estimated time it may take the user to fulfill the keyword's requirements.

Data collection screen 300 also includes description text box 340. A user collects requirements corresponding to the keyword, and enters the requirements in free form text in description text box 340. Processing matches the free form text with keywords stored in a non-volatile storage area. If processing determines a match, processing creates a link between the matched free form text and other subject records that include the matched keyword (see FIG. 6 and corresponding text for further details regarding keyword matching). Processing also highlights the matched free form text that indicates to the user that the highlighted text is a keyword in a different subject record, such as highlighted keywords 345 and 347. If the user selects the highlighted text, processing displays subject records that include the matched keyword (see FIGS. 2, 6, and corresponding text for further details regarding text highlighting and linking).

Data collection screen 300 includes comments text box 350 where a user may enter various comments, such as what person provided a particular requirement or a person's contact information. The user may enter an action item description corresponding to achieving the action item's requirements in action item text box 360 and an action item's due date in due date text box 370.

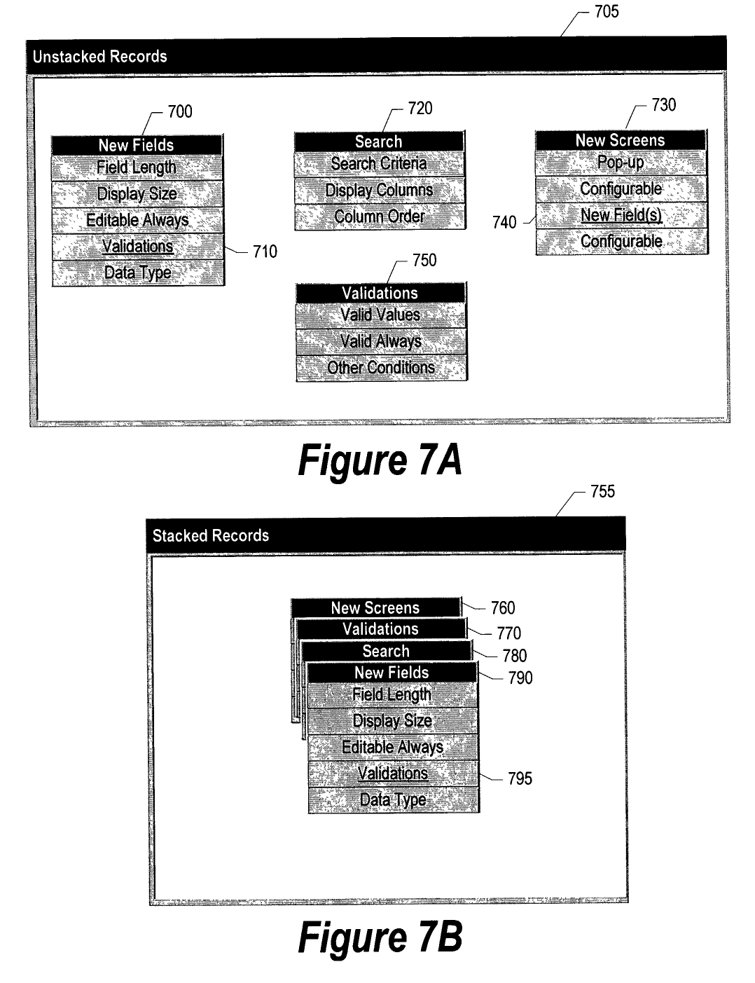

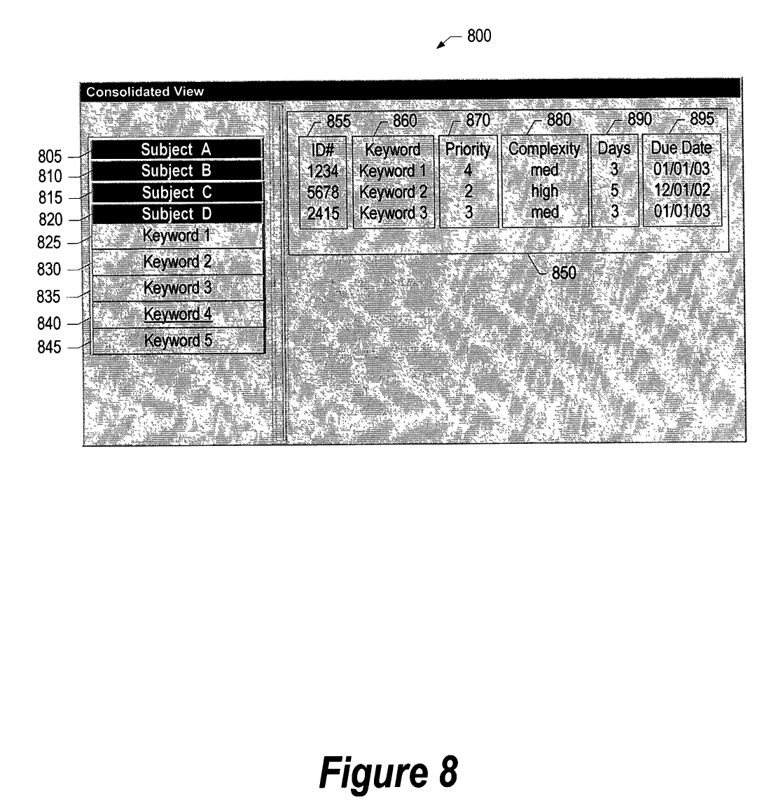

FIG. 4 is a high level flowchart showing a user sending a request corresponding to requirement gathering activities. Processing commences at 400, whereupon processing retrieves one or more subject records from subject record and keyword store 405, and displays the subject records at step 410. Processing may display the subject records in a consolidated view, an unstacked view, or a stacked view (see FIGS. 7A, 7B, 8, and corresponding text for further details regarding subject record views).

The user views the subject records and sends request 425. The user may be gathering requirements for a new software development, and may use the subject records as reminders as to what questions to ask a customer or a computer programmer. For example, the subject records may be titled “Database”, “Validations”, and “Search”. Each subject record includes one or more keywords associated with the subject record. Using the example described above, keywords included in the subject record “Database” may be “Data Type”, “Nullable”, “Default”, “Performance”, and “Migration”. If one of the keywords has a corresponding subject record, the keyword is highlighted (i.e. underlined). Using the example described above, “Migration” may have a corresponding subject record that includes keywords that segment “Migration” into more detail.

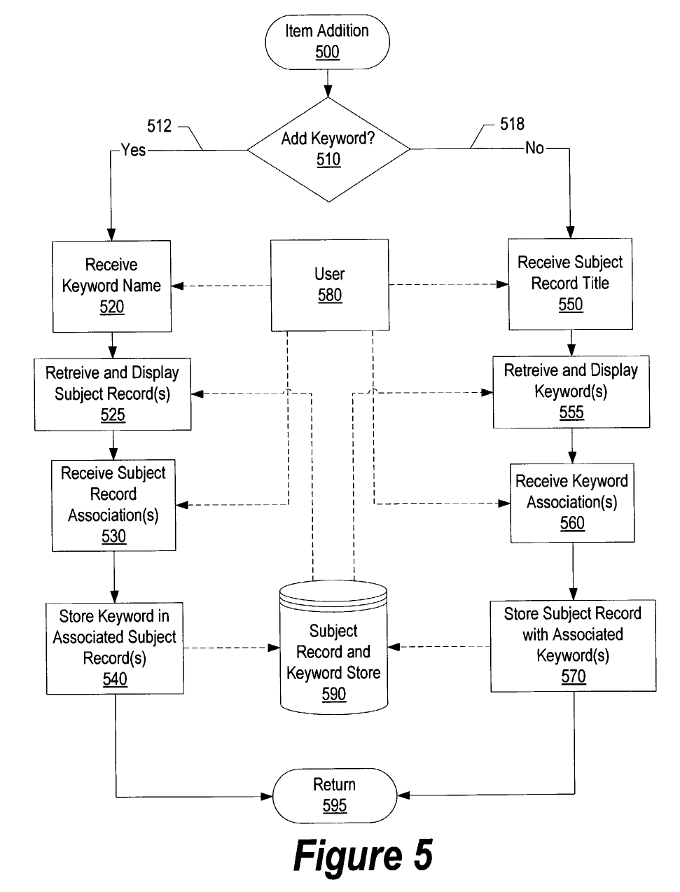

Processing receives request 425 at step 420, whereupon a determination is made as to whether user 415 wishes to add a new subject record or add a new keyword (decision 430). Using the example described above, user 415 may wish to add a new subject record named “New Screens”. If user 415 wishes to add a new keyword or subject record, decision 430 branches to “Yes” branch 432 whereupon a new item is processed and stored in subject record and keyword store 405 (pre-defined process block 435, see FIG. 5 and corresponding text for further details). On the other hand, if user 415 does not wish to add a new keyword or subject record, decision 430 branches to “No” branch 438, bypassing item addition steps.

A determination is made as to whether user 415 wishes to view a particular subject record (decision 440). User 415 may select a different subject record or select an underlined keyword within the current subject record. Using the example described above, the user may wish to view the subject record “Search”. If the user wishes to view a different subject record, decision 440 branches to “Yes” branch 442 whereupon processing retrieves the requested subject record and displays it at step 450. On the other hand, if the user does not wish to view a different subject record, decision 440 branches to “No” branch 448, bypassing subject record retrieval steps.

A determination is made as to whether user 415 wishes to add data corresponding to a particular keyword (decision 460). User 415 may wish to add free form text, assign an action item, and specify various parameters of a keyword (see FIG. 3 and corresponding text for further details regarding data collection). If user 415 wishes to add data to a particular keyword, decision 460 branches to “Yes” branch 462 whereupon processing receives data from user 415 and stores the data in data collection store 475 (pre-defined process block 470, see FIG. 6 and corresponding text for further details).

A determination is made as to whether user 415 has more requests (decision 480). If the user has more requests, decision 480 branches to “Yes” branch 482 which loops back to process the next request. This looping continues until user 415 has no more requests, at which point decision 480 branches to “No” branch 488. Processing ends at 490.

FIG. 5 is a flowchart showing a user adding a new keyword or a new subject record. Item addition processing commences at 500, whereupon a determination is made as to whether a user wishes to add a keyword or a subject record (decision 510). If the user wishes to add a new keyword, decision 510 branches to “Yes” branch 512 whereupon processing receives a keyword name from user 580 at step 520. For example, the user may wish to add a keyword “Memory Size”.

Processing retrieves stored subject records from subject record and keyword store 590, and displays them at step 525. User 580 decides which subject records should include the new keyword, and processing receives user 580's selection at step 530. Using the example described above, user 580 may select a subject record “Database” to include the new keyword “Memory Size”. Processing stores the new keyword with the selected subject records in subject record and keyword store 590 at step 540.

On the other hand, if user 580 wishes to add a subject record, decision 510 branches to “No” branch 518 whereupon processing receives a subject record title from user 580 (step 550). For example, the user may wish to add a “Security” subject record. Processing retrieves stored keywords from subject record and keyword store 590, and displays them at step 555. User 580 decides which keywords should be included in the new subject record, and processing receives user 580's selection at step 560. Using the example described above, user 580 may select keywords “Firewalls” and “Auditing” to include in the “Security” subject record. Processing stores the new subject record with the selected keywords in subject record and keyword store 590 at step 570. Processing returns at 595.

FIG. 6 is a flowchart showing steps taken in receiving free form text and matching the free form text with stored keywords and subject records. Data collection processing commences at 600, whereupon processing receives free form text from user 615 at step 610. The free form text is stored in data collection store 625 at step 620. Processing retrieves stored keywords from subject record and keyword store 635 at step 630. Processing matches the free form text with each stored keyword at step 640. In one embodiment, processing uses a word number configuration property that corresponds to the number of successive words that processing matches with keywords. For example, if the word number configuration property is “3”, then processing progressively matches up to three words at a time to stored keywords. Using this example, if user 615 typed in words “one two three”, then processing compares word “three” with stored keywords, the compares words “two three” with stored keywords, then compares words “one two three” with stored keywords.

A determination is made as to whether the free form text matches a stored keyword (decision 650). If the free form text matches a keyword, decision 650 branches to “Yes” branch 658 whereupon processing creates a link between the free form text and subject records that include the matched keyword (step 660). For example, processing may create an object using the matched free form text, and store location information of the matched keyword in the object. Processing highlights the matched free form text on display 675 at step 670. The highlighted text informs the user that subject records exist that include a keyword matching the free form text. The user may select the highlighted text which invokes processing to display the matching subject records.

On the other hand, if processing does not match the free form text with a keyword, decision 650 branches to “No” branch 652, bypassing free form text linking and highlighting steps. A determination is made as to whether the user inputs more free form text (decision 680. If the user inputs more free form text, decision 680 branches to “Yes” branch 682 which loops back to retrieve (step 685) and process the next free form text. This looping continues until user 615 does not input more free form text, at which point decision 680 branches to “No” branch 688. Processing ends at 690.

FIG. 7A is a group of unstacked subject records with corresponding keywords. A user arranges subject records in an unstacked manner if he wishes to view keywords for each subject record. A user arranges subject records in a stacked manner if the user wishes to conserve screen space (see FIG. 7B and corresponding text for further details regarding stacked subject records).

Unstacked records screen 705 includes subject record 700, subject record 720, subject record 730, and subject record 750 which are subject records for a particular project and are arranged in an unstacked manner. Subject record 700 includes five keywords, one of which is underlined, which indicates that the keyword has a corresponding subject record. Keyword 710's corresponding subject record is subject record 750. Subject record 750 includes keywords that segment keyword 710 into more detail. When a user selects keyword 710, processing highlights subject record 750. The user is able to “drill down” through various subject records and keywords to view data for each keyword in a keyword's data collection screen (see FIG. 2 and corresponding text for further details regarding subject record and keyword selections).

Subject record 720 includes three keywords, none of which are underlined. A user may select each keyword in subject record 720 and view the keyword's corresponding data collection screen. Subject record 730 includes four keywords, one of which is underlined. Keyword 740's corresponding subject record is subject record 700. When a user selects keyword 740, processing highlights subject record 700.

FIG. 7B is a group of stacked subject records with corresponding keywords. A user arranges subject records in a stacked manner if the user wants to conserve screen space. A user arranges subject records in an unstacked manner if he wishes to view keywords for each subject record (see FIG. 7A and corresponding text for further details regarding unstacked subject records).

Stacked records screen 755 includes subject record 760, subject record 770, subject record 780, and subject record 790 which correspond to a particular project and are arranged in a stacked manner. The user is unable to see keywords corresponding to each subject record other than the subject record in the front of the stack, such as subject record 790. Subject record 790 includes five keywords, one of which is underlined. Keyword 795 has a corresponding subject record which is subject record 770. When the user selects keyword 795, processing moves subject record 770 to the front of the stack so the user may view keywords included in subject record 770. Otherwise, the user may select non-underlined keywords in subject record 790 and processing displays the selected keyword's corresponding data collection screen.

FIG. 8 is a user interface screen showing a consolidated view of various subject records and corresponding keyword information. A user may wish to view subject records using a consolidated view in order to show keyword information for each subject record in a list format.

Consolidated view 800 includes four subject records which are subject record 805, subject record 810, subject record 815, and subject record 820. Subject record 820 is in front of the subject record stack and includes five keywords which are keyword 825, keyword 830, keyword 835, keyword 840, and keyword 845. If a user added information in a data collection screen corresponding to one of the keywords, the keyword along with corresponding information appears in list 850. The example shown in FIG. 8 shows that the user has entered information in data collection screens corresponding to keyword 825, keyword 830, and keyword 835.

List 850 includes six columns which are identification column 855, keyword column 860, priority column 870, complexity column 880, timeframe column 890, and due date column 895. Identification column 855 includes a identification number corresponding to each keyword. Processing may automatically generate the identification number when a user enters information in a corresponding data collection screen. Keyword column 860 includes a name of each keyword that has information in its corresponding data collection screen. Priority column 870 includes a priority level that a user assigns for each displayed keyword. Complexity column 880 includes a complexity level that a user assigns for each displayed keyword. Timeframe column 890 includes a time estimate that a user assigns that estimates how long it may take to achieve the keyword's requirements. Due date column 895 includes a due date to meet corresponding requirements for each keyword.

Keyword 840 is underlined which indicates that keyword 840 has a corresponding subject record. When the user selects keyword 840, processing displays the corresponding subject record at the front of the subject record stack. The user may then view keywords corresponding to the selected subject record. The user may also select other subject records shown in the stack and processing moves the selected subject record to the front of the stack for the user to view.

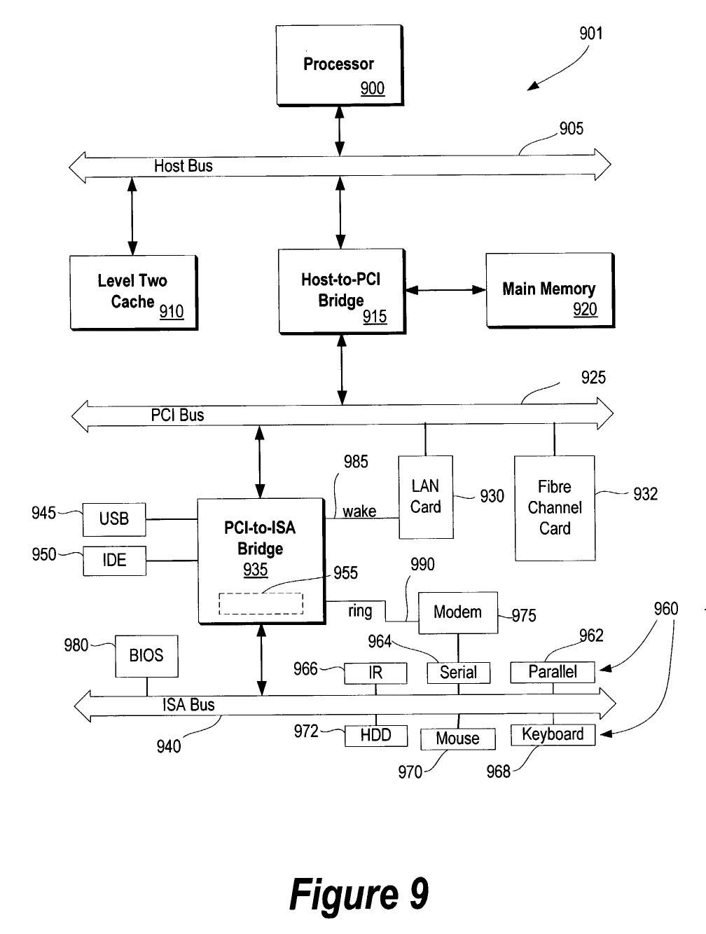

FIG. 9 illustrates information handling system 901 which is a simplified example of a computer system capable of performing the invention described herein. Computer system 901 includes processor 900 which is coupled to host bus 905. A level two (L2) cache memory 910 is also coupled to the host bus 905. Host-to-PCI bridge 915 is coupled to main memory 920, includes cache memory and main memory control functions, and provides bus control to handle transfers among PCI bus 925, processor 900, L2 cache 910, main memory 920, and host bus 905. PCI bus 925 provides an interface for a variety of devices including, for example, LAN card 930. PCI-to-ISA bridge 935 provides bus control to handle transfers between PCI bus 925 and ISA bus 940, universal serial bus (USB) functionality 945, IDE device functionality 950, power management functionality 955, and can include other functional elements not shown, such as a real-time clock (RTC), DMA control, interrupt support, and system management bus support. Peripheral devices and input/output (I/O) devices can be attached to various interfaces 960 (e.g., parallel interface 962, serial interface 964, infrared (IR) interface 966, keyboard interface 968, mouse interface 970, and fixed disk (HDD) 972) coupled to ISA bus 940. Alternatively, many I/O devices can be accommodated by a super I/O controller (not shown) attached to ISA bus 940.

BIOS 980 is coupled to ISA bus 940, and incorporates the necessary processor executable code for a variety of low-level system functions and system boot functions. BIOS 980 can be stored in any computer readable medium, including magnetic storage media, optical storage media, flash memory, random access memory, read only memory, and communications media conveying signals encoding the instructions (e.g., signals from a network). In order to attach computer system 901 to another computer system to copy files over a network, LAN card 930 is coupled to PCI bus 925 and to PCI-to-ISA bridge 935. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method of managing information that includes a plurality of keywords, said method comprising:
displaying a data collection screen, wherein the data collection screen corresponds to a first keyword selected from the plurality of keywords;
receiving free form text corresponding to the first keyword, the free form text including one or more free form words;
matching one or more of the free form words with one or more of the keywords, the matching resulting in an identified word; and
linking the identified word to the corresponding matched keywords.

2. The computer implemented method as described in claim 1 further comprising:
creating a hyperlink for the identified word; and displaying the hyperlink on a display, wherein the displaying includes highlighting the identified word.

3. The computer implemented method as described in claim 1 further comprising:
receiving a selection corresponding to the identified word;
retrieving one or more subject records in response to the selection, wherein the subject records correspond to the identified word; and
displaying one or more of the subject records.

4. The computer implemented method as described in claim 1 further comprising:
displaying a first subject record prior to the displaying of the data collection screen, wherein the first subject record includes the first keyword; and
receiving a first selection corresponding to the first keyword, wherein the receiving results in the displaying of the data collection screen.

5. The computer implemented method as described in claim 4 further comprising:
displaying a second subject record prior to the displaying of the first subject record, wherein the second subject record includes a second keyword; and
receiving a second selection corresponding to the second keyword, wherein the receiving results in the displaying of the first subject record.

6. The computer implemented method as described in claim 4 further comprising:
selecting one or more keywords from the plurality of keywords, wherein the first subject record includes the selected keywords; and
prompting a user to select one or more of the keywords included in the first subject record.

7. The computer implemented method as described in claim 1 further comprising:
receiving keyword data corresponding to one or more text boxes, wherein at least one of the text boxes is selected from the group consisting of an identification number text box, a product text box, an abstract text box, a priority text box, a complexity text box, a time estimate text box, a comments text box, an action item text box, and a due date text box.

8. An information handling system comprising:
one or more processors;
a memory accessible by the processors;
one or more nonvolatile storage devices accessible by the processors; and
an information management tool to manage information that includes a plurality of keywords, the information management tool including:
means for displaying a data collection screen on a display device, wherein the data collection screen corresponds to a first keyword selected from the plurality of keywords;
means for receiving free form text from one of the non-volatile storage devices corresponding to the first keyword, the free form text including one or more free form words;
means for matching one or more of the free form words with one or more of the keywords, the matching resulting in an identified word; and
means for linking the identified word to the corresponding matched keywords.

9. The information handling system as described in claim 8 further comprising:
means for creating a hyperlink for the identified word; and
means for displaying the hyperlink on the display device, wherein the displaying includes highlighting the identified word.

10. The information handling system as described in claim 8 further comprising:
means for receiving a selection corresponding to the identified word;
means for retrieving one or more subject records from one of the nonvolatile storage devices in response to the selection, wherein the subject records correspond to the identified word; and
means for displaying one or more of the subject records on the display device.

11. The information handling system as described in claim 8 further comprising:
means for displaying a first subject record on the display device prior to the displaying of the data collection screen, wherein the first subject record includes the first keyword; and
means for receiving a first selection corresponding to the first keyword, wherein the receiving results in the displaying of the data collection screen.

12. The information handling system as described in claim 11 further comprising:
means for displaying a second subject record on the display device prior to the displaying of the first subject record, wherein the second subject record includes a second keyword; and
means for receiving a second selection corresponding to the second keyword, wherein the receiving results in the displaying of the first subject record.

13. The information handling system as described in claim 8 further comprising:
means for receiving keyword data corresponding to one or more text boxes, wherein at least one of the text boxes is selected from the group consisting of an identification number text box, a product text box, an abstract text box, a priority text box, a complexity text box, a time estimate text box, a comments text box, an action item text box, and a due date text box.

14. A computer program product stored on a computer operable media for managing information that includes a plurality of keywords, said computer program product comprising:
means for displaying a data collection screen, wherein the data collection screen corresponds to a first keyword selected from the plurality of keywords;
means for receiving free form text corresponding to the first keyword, the free form text including one or more free form words;
means for matching one or more of the free form words with one or more of the keywords, the matching resulting in an identified word; and
means for linking the identified word to the corresponding matched keywords.

15. The computer program product as described in claim 14 further comprising:
means for creating a hyperlink for the identified word; and
means for displaying the hyperlink on a display, wherein the displaying includes highlighting the identified word.

16. The computer program product as described in claim 14 further comprising:
means for receiving a selection corresponding to the identified word;
means for retrieving one or more subject records in response to the selection, wherein the subject records correspond to the identified word; and
means for displaying one or more of the subject records.

17. The computer program product as described in claim 14 further comprising:
means for displaying a first subject record prior to the displaying of the data collection screen, wherein the first subject record includes the first keyword; and
means for receiving a first selection corresponding to the first keyword, wherein the receiving results in the displaying of the data collection screen.

18. The computer program product as described in claim 17 further comprising:
means for displaying a second subject record prior to the displaying of the first subject record, wherein the second subject record includes a second keyword; and
means for receiving a second selection corresponding to the second keyword, wherein the receiving results in the displaying of the first subject record.

19. The computer program product as described in claim 17 further comprising:
means for selecting one or more keywords from the plurality of keywords, wherein the first subject record includes the selected keywords; and
means for prompting a user to select one or more of the keywords included in the first subject record.

20. The computer program product as described in claim 14 further comprising:
means for receiving keyword data corresponding to one or more text boxes, wherein at least one of the text boxes is selected from the group consisting of an identification number text box, a product text box, an abstract text box, a priority text box, a complexity text box, a time estimate text box, a comments text box, an action item text box, and a due date text box.
